(19) United States
(12) Patent Application Publication
(10) Pub. No.: US 2007/0137076 A1
(43) Pub. Date: Jun. 21, 2007

(54) CHANGEABLE INFORMATION DISPLAYS AND METHODS THERFOR

(76) Inventor: Webster L. Cowden III, Wilmington, NC (US)

Correspondence Address: NORA M. TOCUPS, P.O BOX 698, 140 PINECREST AVE, DECATUR, GA, 30030, US

(21) Appl. No.: 11/558,425

(22) Filed: Nov. 9, 2006

Related U.S. Application Data
(60) Provisional application No. 60/734,897, filed on Nov. 9, 2005.

(51) Int. Cl. G09F 11/18

(52) U.S. Cl. 40/514

(57) ABSTRACT

A display with changeable information and methods of changing information. An information scroll with opposite ends, each may coil, may include one+ display areas. A scroll support with display and opposite retaining sides includes first and second openings for receiving the scroll ends. The scroll is variously positionable between the openings to selectively display one+ display area. The scroll may support one+ information scrolls through the same openings and/or others. A tick catcher on a scroll may catch a tick to retain the scroll's end in an opening. A frame may be positioned on the support's display side to frame a display area of the scroll. Framing may cause at least some pressure on a part of the scroll to facilitate movement of the scroll between openings in the support. The frame and support may be unitary. A spacer(s) may be inserted between the support and frame.

### RELATED APPLICATION

This application claims priority to and the benefit of the prior filed co-pending and commonly owned provisional application entitled “CHANGEABLE INFORMATION DISPLAYS AND METHODS THEREFOR”, which was filed with the United States Patent and Trademark Office on Nov. 9, 2005, which was assigned U.S. Patent Application Ser. No. 60/734,897, and which is incorporated herein by this reference.

### FIELD OF THE INVENTIONS

The inventions relate to apparatuses for displaying information and methods therefor. The apparatuses and methods allow the displayed information to be changed quickly and easily.

### BACKGROUND

Advertising displays and signage have always been an extremely important way for businesses to impart information about their products or services in an attractive and effective manner. Millions of dollars and lots of time are spent by companies each year to update their signage with current information. If signage is not kept current, then customers may rely on incorrect information and become frustrated and upset. Companies not only lose the opportunity to promote particular items but also credibility with consumers when signage is outdated. Apart from commercial enterprises, individuals and other institutions also use information displays and signage that often must be kept current.

Most signage contains a message which is permanently printed on various media, i.e. paperboard, plastic, etc. and is displayed until the information is out of date, when the sign then needs to be replaced completely. Sometimes, only a portion of the information on the sign is out of date, such as the price of a product. It does not look professional, however, to edit just a portion of a sign, the display generally is replaced with an entirely new sign. Thus, there exists a need for a display sign which can be designed with one or more areas of information that can be changed as needed without having to replace the existing sign with a completely new display sign.

Companies must commit employee time and/or company resources to physically keep signage current. If signs must be changed out by employees, then time must be put aside to perform that task. If there are no employees available, or the sign is too large or difficult to be changed in-house, then another person or company must be hired to change the signage. Thus, there exists a need for a display sign which can be easily updated in minutes by anyone, saving time and money.

Existing products address some of the problems of traditional static signage. U.S. Pat. No. 4,292,752 offers a permanent display sign which can be updated with copy inserts; however, this type of sign, because of its large size and permanency, would not be practical for use in small areas, such as store shelves. U.S. Pat. No. 4,930,795 introduces the idea of a rotating advertising display which can be used on something like a shopping cart, but this display rotates continuously and can only hold a small amount of messages. U.S. Pat. No. 5,966,854 shows a coiled display sign, however, the invention teaches only how the information can be rolled or unrolled but does not address how to easily update the information.

In sum, there exists a need for an apparatus and method that has a design which is flexible in size, shape, and display possibilities, which can hold a relatively large amount of advertising or information, and which can be quickly and easily changed by employees themselves. None of the known examples of prior art provide such a versatile information display that is easy and economical to keep updated.

### SUMMARY

Stated generally, the inventions relate to information displays and methods wherein the information on display, or parts thereof, may be readily changed. More particularly, the inventions relate to information displays and methods which may utilize one or more self-coiling information scrolls. The scrolls are supported by and may be moved or positioned upon or with respect to a scroll support. Each scroll may have one or more display blocks printed on it, and one or more of these display blocks may convey information such as when the scroll is positioned between openings in the scroll support. One or more of these display blocks may be visible through openings in an optional frame that may be placed upon or positioned with respect to the support. The scroll may be situated between the support and the frame and can be moved so that the desired display block is shown in the frame opening. Scrolls may be aligned for a side-by-side (horizontal and/or vertical) display of the respective display blocks of the scrolls, and/or these side-by-side scrolls may be supported by the same or different openings in the scroll support. An information display according to the inventions may include scrolls in other positions on a scroll support other than the side-by-side scrolls already mentioned.

Advantageously, the inventions provide an apparatuses and methods that have a design, which is flexible in size, shape, and display possibilities, and can hold a relatively large amount of advertising or information, which can be quickly and easily changed. A particular advantage of the inventions is the simplicity of the structure. In a simple embodiment, the information display may consist of only a scroll and scroll support. Other simple embodiments may include one or more scrolls, a scroll support, and also may include a frame framing the information areas on the scrolls.

Additional advantages of the inventions are that the signage provided may be more easily kept up to date than previous signs, and such upkeep may be carried out even by first time users. Moreover, when information on an exemplary embodiment needs changing, the entire sign does not need to be replaced. A small movement or repositioning of the appropriate information scroll(s) quickly and effectively changes the information as needed. These features make the inventions easy to use and also economical because the costs and other expenses associated with the purchase of new signage may be avoided.

Further advantages of the inventions include the fact that a single embodiment may include more than one changeable information area. All such information areas may be changed at the same time, or only select area(s) may be changed. For example, assume a display for a 6-pack of soft drinks includes three information areas corresponding to the price of $1.99. If the price decreases by a dime, then only one of the information areas need be changed to display the new price of $1.89. The other two information areas do not need to be changed.

Yet another advantage of the inventions is that they may be incorporated in signage that is small or large, may be of almost any shape, and include few or a lot of display areas for changeable information.

Finally, a particular advantage of the inventions is that they allow for a relatively large amount of information to be available so that the same sign may be used for many different messages. For example, for pricing, an exemplary display may include an information scroll having all the numbers that may be relevant to the price of an object advertised. As another example, a calendar may include an information scroll with all of the months, another information scroll with the days of the week, a third information scroll with possible dates, and a fourth information scroll for years. Alternatively, another calendar may include only a single scroll with all of the relevant information and the single scroll may be advanced day by day.

Additional details are now provided regarding exemplary embodiments that may be made pursuant to the claimed inventions. An exemplary information display may include an information scroll with two opposite ends. The information scroll may include an inner surface, and an outer surface with two or more display areas. The two opposite ends of the information scroll may include ends that are coilable towards each other and towards the inner surface of the information scroll. Alternative embodiments of the invention may include additional information scrolls in the same information display (as further described below).

The exemplary information display also includes a scroll support having a display side and a retaining side opposite the display side. The scroll support further includes a first opening and a second opening. The first opening may be spaced apart from the second opening on the scroll support by about either the height or the width of the display area of the information scroll (depending on the orientation of movement of the scroll, i.e., whether up or down, or right or left). The information scroll may be positionable between the first and second openings so as to selectively serially display one of the two or more display areas one-at-a-time.

Regarding the scroll support, its first opening receives a first end of the information scroll and its second opening receives a second end of the information scroll so that the first and second ends rest against the retaining side of the scroll support. The outer surface of the information scroll is visible between the first and second openings on the display side of the scroll support. The information scroll is positionable between the first and second openings so as to selectively display at least one of the two or more display areas.

In this exemplary information display, the first opening of the scroll support includes at least a tick. The information scroll includes at least a tick catcher near the termination of the first end of the information scroll. The tick catcher catches the tick of the first opening to retain the termination of the first end of the information scroll in the first opening.

This exemplary information display may also include a frame for framing the display side of the scroll support. The frame may include a frame opening at least as large as the largest of the two or more display areas of the information scroll. The frame and the scroll support may be a unitary piece. The framing of the display side of the scroll support by the frame may cause at least some pressure on at least a part of the information scroll so as to facilitate movement of the information scroll between the openings in the scroll support. An alternative embodiment may include one or more spacers inserted between the frame and the scroll support.

As noted, alternative embodiments of the invention may include additional information scrolls in the same information display. One or more additional information scrolls may be positioned next to the first information scroll so that at least a display area of each of the other information scrolls is visible between the first and second openings on the display side of the scroll support.

Other embodiments may include additional openings such as third and fourth openings. The third opening may receive a first end of an information scroll and the fourth opening may receive a second end of the an information scroll so that the first and second ends of the information scroll rest against the retaining side of the scroll support. The display area of the information scroll is visible between the third and fourth openings on the display side of the scroll support.

The inventions also relate to exemplary methods for displaying information. Per an exemplary method, an information scroll is caused to include at least an information display on a display side of the information scroll. The information scroll is coilable from either end towards an inner side of the information scroll opposite to the display side of the information scroll. A scroll support is provided for supporting the information scroll between a first opening, which receives at least a first end of the information scroll, and a second opening, which receives at least second end of the information scroll. The information display may be positioned between the first and second openings of the scroll support by causing a first end of the information scroll to coil and the second end of the information scroll to uncoil until the information display is positioned substantially between the first and second openings of the scroll support.

An alternative exemplary method may include another information display on the display side of the information scroll. This method causes the first end of the information scroll to coil and the second end of the information scroll to uncoil with the result that the other information display is positioned substantially between the first and second openings of the scroll support. Causing the first end of the information scroll to coil may include causing the first end of the information scroll to further coil. Further, the exemplary method (or others) may include provision of a frame for framing the information display between the scroll support and the frame.

The features and advantages of the inventions may be more clearly understood and appreciated from a review of the following drawings, detailed description of exemplary embodiments, and the claims.

### BRIEF DESCRIPTION OF THE DRAWINGS

FIG. 1A is a perspective view of an exemplary information display in the form of a calendar pursuant to the inventions.

FIG. 1B is a top view of the exemplary calendar illustrated in FIG. 1A.

FIG. 1C is a perspective view of an exemplary information scroll as may be used in the exemplary calendar illustrated in FIG. 1A.

FIG. 1D is a back view of an exemplary information scroll and scroll support as may be used in the exemplary calendar illustrated in FIG. 1A

FIG. 2 is a perspective view of another exemplary embodiment pursuant to the inventions.

FIG. 3 is a side slightly exploded view of an exemplary embodiment pursuant to the inventions.

FIG. 4 is a front view of an exemplary embodiment per the inventions.

### DETAILED DESCRIPTION

Generally stated, the inventions relate to information displays where the information may be changed in whole or part, and methods therefor. An exemplary information display may include one or more information scroll(s), a scroll support and frame as well as other features. The information displays of the inventions may be displayed in a free-standing manner, mounted on supports, hung, attached by suction cups or other means to a surface, or otherwise positioned for display.

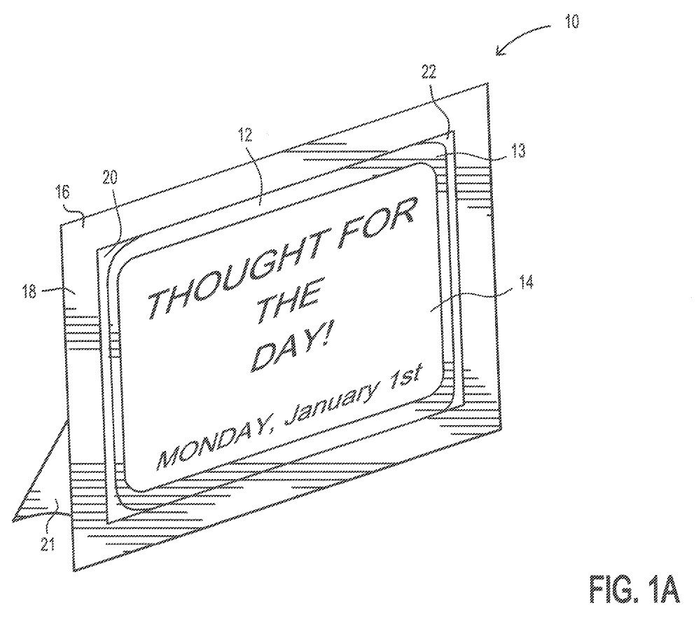

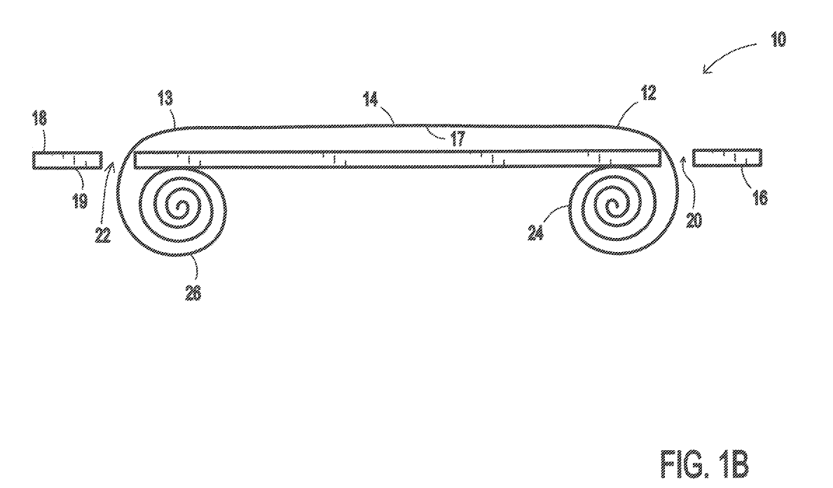

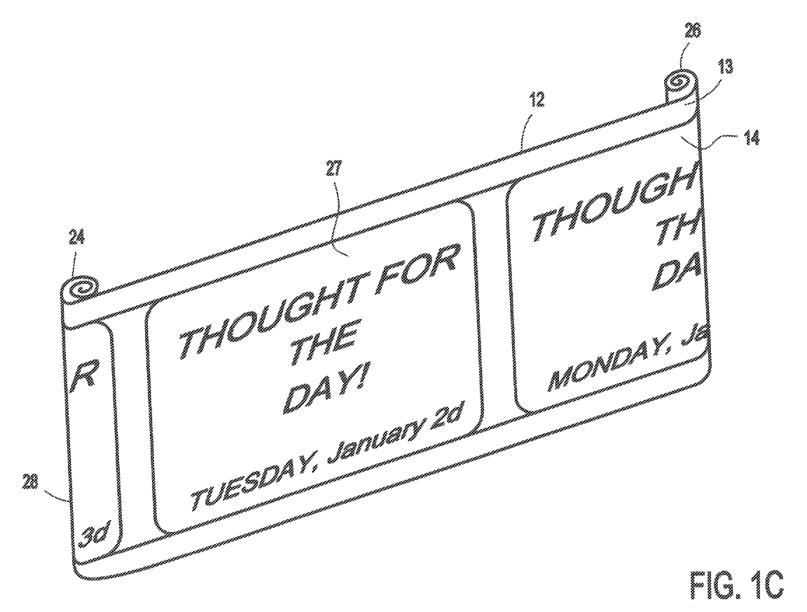

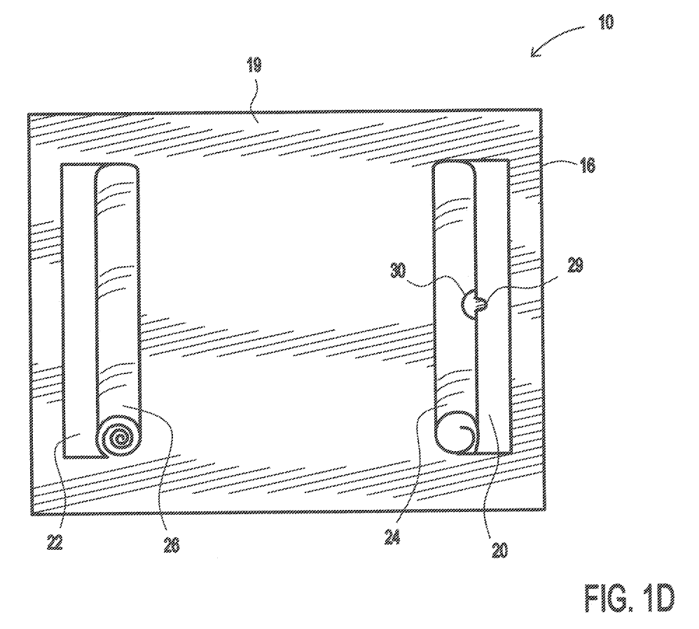

### FIGS. 1A-1D—An Exemplary Embodiment

FIG. 1A illustrates a relatively simple embodiment of the inventions in a “Thought for the Day!” calendar 10. The calendar 10 includes an information scroll 12, a scroll support 16, and a support (or leg) 21 allowing for a relatively upright display of the calendar 10.

In particular, the calendar 10 includes an information scroll 12 that may be moved from left to right (and vice versa) to change the display. This information scroll 12 is generally rectangular in shape having two opposite ends and being much wider than it is tall (or high) in this example (other sizes and shapes are possible in other embodiments). The information scroll 12 includes a surface 13 with two or more display areas. FIG. 1A shows one of these display areas as showing: “THOUGHT FOR THE DAY! Monday, January 1^{st}” 14. The surface 13 of the information scroll 12 with the display area 14 is referred to as the outer surface 13 herein because it faces away from a scroll support 16. The surface opposite to the outer surface (facing the scroll support 16) is referred to herein as the inner surface 17 (not shown in FIG. 1A).

The calendar's scroll support 16 is generally flat and rectangular in shape in this example (other sizes and shapes are possible in other embodiments). The scroll support 16 includes a display side 18 and a retaining side 19 opposite to the display side (not shown in FIG. 1A).

The scroll support 16 also includes a first opening 20 and a second opening 22 separated by an area on the display side 18 of the scroll support 16 where the display area 14 of the information scroll 12 is positioned and displayed. The first opening 20 of the scroll support 16 receives a first end 24 of the information scroll 12 from the display side 18 of the scroll support 16 so that the first end 24 passes through the first opening 20 and comes to rest against the retaining side 19 of the scroll support 16. The second opening 22 receives the second end 26 of the information scroll 12 from the display side 18 of the scroll support 16 so that the second end 26 passes through the second opening 22 and comes to rest against the retaining side 19 of the scroll support 16. With the two ends 24, 26 of the information scroll 12 resting against the retaining side 19 the scroll support 16, the display area 14 of the information scroll 12 is positioned between the first and second openings 20, 22 of the scroll support 16. Generally, the first and second openings 20, 22 are sized tall or high enough to accommodate the height of the information scroll 12, and are sized wide enough to accommodate receiving a substantially completely coiled end 24, 26 of the information scroll 12.

The scroll support 16 of the exemplary calendar 10 may be made of any appropriate material to carry out its support function. Materials that may be used include: paper products including poster board, cardboard, corrugated cardboard; plastic, and wood products such as particle board, wood laminate, plywood, or like materials.

FIG. 1B is a top view of exemplary calendar 10. This top view illustrates one manner in which the scroll ends 24, 26 may rest against the retaining side 19 the scroll support 16 while the display area 14 of the scroll 12 is positioned on the display side 18 the scroll support 16 between the openings 20, 22 in the scroll support 16. In particular, FIG. 1B illustrates that the scroll ends 24, 26 rest to the inside side of their respective openings 20, 22 of the scroll support. Other manners of causing the scroll ends to rest against the retaining side may be used in other embodiments.

The information scroll 12 of the calendar 10 includes ends 24, 26 that self-coil towards each other. Placing an end 24, 26 through an opening 20, 22 and releasing the same end 24, 26 allows that end 24, 26 to coil in on itself at least partly with the coiled end 24, 26 resting against the retaining side 19 of the scroll support 16. After the other end 24, 26 is placed through its opening 20, 22 and released, that other end 24, 26 also coils in on itself at least partly and rests against the retaining side 19. One of the ends 24, 26 coils in a clockwise direction, and the other end coils in a counter-clockwise direction. When positioned through the openings 20, 22 in the scroll support 16, the ends 24, 26 by their tendency to self coil in opposite directions allow for the display area 14 of the scroll 12 to remain in position across the area between the openings 20, 22 on the display side 18 of the scroll support 16. The ends 24, 26 may be said to rest “actionably” behind or against the retaining side 19 of the scroll support 16 because the ends 24, 26 may be kept in place by their coiling action, but may be unwound as necessary to change the display of information.

As noted, the information scroll 12 of the exemplary calendar 10 includes ends 24, 26 that tend to or may be made to tend to self coil towards the inner surface of the scroll 12 and towards each other. In other words, the exemplary information scroll 12 is made to be biased into a self-coiling, rolled form. In particular, the information scroll 12 may be coiled at and from both of its ends 24, 26 with each end being coilable towards each other end into two connected rolls that are actioned towards each other. When the rolls are parted, they tend through spring action to coil towards each other. An information scroll 12 with such characteristics may be fabricated as a sheet from a number of different kinds of materials including plastics or plastic film. Information about the making of an information scroll such as may be used with the inventions described herein may be found in the patent to Taber, U.S. Pat. No. 3,426,115, which is incorporated herein by reference.

A user may elect to keep the display area 14 of the scroll 12 in position so that it may be on permanent or continuous display. Advantageously, the inventions allow the user to quickly and easily change the information that is displayed. The display area 14 of the scroll 12 may be changed to another display area on the scroll 12 by moving the scroll 12 towards one of its ends so as to further coil that end, which results in uncoiling of the other end of the scroll 12, thereby positioning a different display area of the scroll between the openings 20, 22 on the display side 18 of the scroll support 16. The scroll 12 may be moved in either direction (towards either end) until the desired display area is in position between the openings 20, 22 on the display side 18 of the scroll support.

FIG. 1C illustrates the information scroll 12 of the calendar 10 without the scroll support 16 and in a slightly more pulled apart position than illustrated in FIGS. 1A and 1B. The pulled apart position of scroll 12 in FIG. 1C is provided to show the reader that more than one display area may be included on an information scroll 12. The scroll's display area 14 previously seen in FIGS. 1A and 1B has been moved in FIG. 1C towards its second end 26 (to the right), thereby causing that end 26 to further roll up or self-coil. Thus, only part of display area 14 is visible in FIG. 1C. A new display area 27 “THOUGHT FOR THE DAY! Tuesday, January 2d” has been moved into complete viewing position in FIG. 1C by the rolling up of second end 26 and the unrolling of first end 24. A third display area 28 (presumably “THOUGHT FOR THE DAY! Wednesday, January 3d”) is only partially visible as unrolling or uncoiling from first end 24 of the information scroll 12 as the second end 26 has been further rolled or coiled. Advantageously, the user may return to viewing display area 14 by reversing the movement of the information scroll 12 so as to move it to the left and to cause the first end 24 of the scroll 12 to coil or further coil and the second end 26 to uncoil or unroll.

The exemplary calendar 10 includes an optional feature to aid in keeping the one or both of the ends 24, 26 of the information scroll 12 positioned against the retaining side 19 of the scroll support 16. As noted, to change the display area, a user may simply move the information scroll to the right or to the left (in this embodiment—other embodiments may include up/down movements). To prevent a user from inadvertently causing one end of the scroll 12 to completely uncoil and release itself from its position behind the retaining side of the scroll support, the exemplary embodiment provides a tick and tick catcher feature. This feature may be used at one or both ends of the scroll 12, or it may be completely omitted.

FIG. 1D is a back view of the exemplary calendar 10 also shown in the previous figures. As noted, scroll support 16 includes a first opening 20 that receives first end 24 of the information scroll 12. The first opening 20 is generally rectangular, but the inside side of the first opening 20 is provided with a tick 29 (also referred to as an extension or tab) that slightly protrudes into the first opening 20. In this example, the tick 29 is generally a half circle or extended half circle shaped. The tick 29 protrudes slightly into the first opening 20 so as to allow the first end 24 of the information scroll 12 to be received by the first opening 20, but to also a user to relatively freely coil and uncoil the scroll so as to change the display area of the information scroll.

The tick 29 in the first opening 20 works with a tick catcher 30 in the form of a hole provided near the termination of the first end 24 of the information scroll 12. The tick 29 and tick catcher 30 are generally lined up with each other so that the tick catcher 30 catches the tick 29 by the tick 29 fitting into the tick catcher's hole, thereby holding the termination of the first end 24 through the first opening 20. In this example, the tick 29 and tick catcher 30 are more or less centered with respect to the first opening 20. In the exemplary embodiment, the hold of the tick/tick catcher may be overcome by added pressure to the movement of the uncoiling of the first end of the information scroll 12. The hold of the tick/tick catcher generally suffices to prevent inadvertent complete uncoiling of the first end of the information scroll, but may allow for complete uncoiling subject to slight additional pressure.

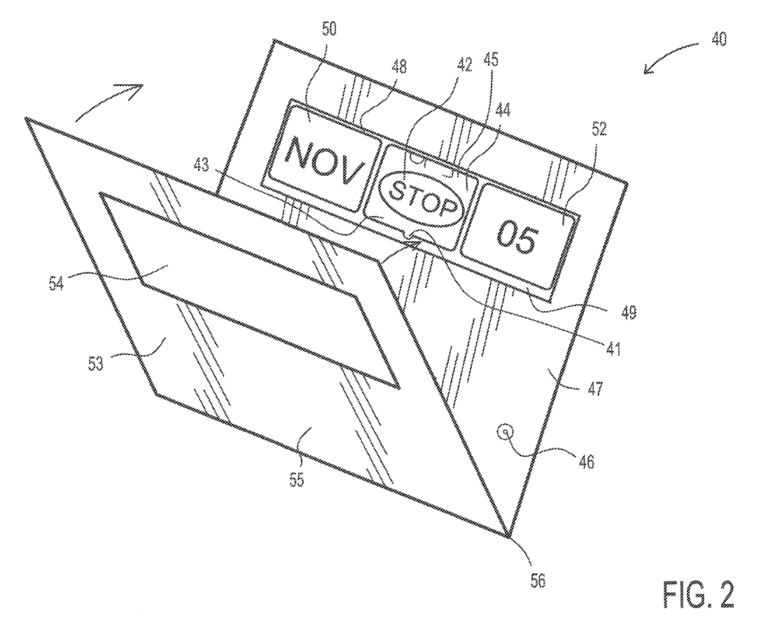

The exemplary calendar 10 includes a tick 29 and tick catcher 30 on only one end 24 of the scroll 12. Another example of a tick 41 is illustrated in the exemplary embodiment 40 shown in FIG. 2. Other embodiments may include the tick/tick catcher combination on both ends of the scroll, fail to include the tick/tick catcher combination on either end, and/or to use an alternate means of selectably retaining the scroll end(s) in place through the opening(s) in the scroll support 16.

An exemplary embodiment provides another feature to warn the user of the complete uncoiling of one or both ends of an information scroll in an information display. This feature is an indicator or warning on the outer surface of the information scroll, and preferably near the termination of an end of the scroll. This indicator provides information that continued movement of the scroll 12 will result in complete uncoiling of the end of the information scroll and possibly dislodging of the end of the scroll from its position behind the retaining side 19 of the scroll support 16.

FIG. 2 shows another embodiment 40 of the inventions wherein the indicator 42 may be seen as used on a scroll 44. In particular, the scroll 44 is shown with its bottom end 43 being substantially unwound (its top end 45 is therefore substantially wound) to the point where the indicator “STOP” 42 appears as the display area of the scroll 44. If the user continues to move the scroll 44 (“scroll the scroll”) in the direction so as to continue to unwind the bottom end 43, then the bottom end 43 will be released from its position behind the retaining side (not shown) of the scroll support 47 and may be dislodged from its position through the bottom opening 49 in the scroll support 47. The indicator or warning feature may be included on both ends of a scroll so that a user does not inadvertently dislodge either end of the scroll, only one end of a scroll, or on neither end of a scroll. Other terms (such as “END” or “TERMINATION”) may be used or graphic symbols in place of or in addition to the “STOP” term.

Further, the indicator or warning feature may be combined (or not) with the tick/tick catcher combination on one or both ends (or no ends) of a scroll of an information display according to the inventions.

### FIG. 2—An Exemplary Embodiment

The exemplary embodiment 40 shown in FIG. 2 is also a calendar, but differs from the previous exemplary embodiment 10 by having three scrolls 44, 50, 52 (rather than just one scroll). Also, the exemplary calendar 40 differs because each of its scrolls 44, 50, 52 may be moved or positioned between a top opening 48 and a bottom opening 49 in a scroll support 47 (rather than having left and right openings). Other embodiments may provide for generally diagonal or otherwise aligned openings, or combinations of generally vertical, horizontal, diagonal, and/or otherwise aligned openings.

Each of the scrolls 50, 44, 52 is generally an elongated rectangle that is much longer than it is wide. The scrolls 50, 44, 52 are of approximately the same width in this example, but may have differing widths in other embodiments. The scrolls 50, 44, 52 are of different lengths, but may be of the same lengths in other embodiments. Of course, other embodiments may use fewer or more scrolls (and differing scrolls from those herein and from each other (or not)) that may or may not share the same opening(s) in a scroll support.

Also, the scrolls 50, 44, 52 have display areas of approximately the same size throughout a particular scroll and also compared to the other scrolls. Other embodiments, however, may have scrolls whose display areas differ in size within a scroll and also with respect to other scrolls, even if the scrolls of different display area size share the same openings. The different display areas may be accommodated by differences in the size and/or shape of the openings in the scroll support of a particular embodiment, and/or of the frame and/or frame opening(s) of a particular embodiment.

Further, the scrolls 50, 44, 52 contain respectively different display information. The scroll 50 includes display areas for each month of the year, the scroll 44 includes display areas for each date possible in a month of the year, and the scroll 52 includes display areas for years. To set the date, a user positions the month scroll 50 to its appropriate display showing the current month, positions the date scroll 44 to its appropriate display area showing the current date, and positions the year scroll 52 to its appropriate display area showing the current year. A user “positions” a scroll in this example by moving it up towards the top opening 48 or down towards the bottom opening 49 in the scroll support until the desired display area is showing between the openings 48, 49. Advantageously, one of the three scrolls 50, 44, 52 may be wound without winding the other scrolls so that a date may be changed, for example, without having to change the month and/or the year.

In this example, each of the three scrolls 50, 44, 52 is of approximately the same width, but of different lengths having different numbers of display areas (scroll 50 includes 12 display areas—one for each month; scroll 44 includes 31 display areas—one for each possible date in a month). Other embodiments may be made to be the same length or otherwise.

FIG. 2 shows that the three scrolls 50, 44, 52 share the same openings 48, 49, which are substantially the same size and shape, and are positioned horizontally generally parallel to each other. The openings 48, 49 are generally elongated wide rectangles to accommodate the total width of the three scrolls 50, 44, 52, and have a common height about the diameter of the biggest of the three scrolls 50, 44, 52 when it is more or less substantially wound completely upon itself. Other embodiments may have openings of differing size and shape and positioning so as to accommodate scrolls of different widths, lengths, sizes, shapes, etc.

FIG. 2 also shows use of a tick 41 in holding a bottom end 43 of a scroll 44 in its bottom opening 49 so as to prevent the inadvertent dislodging of the scroll end 43 from the bottom opening 491. The tick 41 is half-circle shaped and protrudes slightly into the bottom opening 49 from the top of the bottom opening 49. The other scrolls 50, 52 may have tick/tick catcher combinations on their respective ends (both ends of a scroll or just one end), but FIG. 2 does not illustrate such tick/tick catcher combinations. Other embodiments may use tick/tick catcher combinations on all of its scrolls, none of its scrolls, only some its scrolls, etc., and/or other means of retaining a scroll end within an opening so as to avoid inadvertent dislodging of the scroll end from the opening.

FIG. 2 illustrates one type of a “frame” feature that may be included in various ways in exemplary embodiments according to the inventions. The frame 53 of the exemplary calendar 40 generally covers the scroll support 47 so that the scroll support 47 remains unseen when the exemplary calendar 40 is displayed (but this does not have to be the case). To cover the scroll support 47, the frame 53 in this example is approximately of the same generally rectangular size and shape as the scroll support 47. In other embodiments, however, a frame may be of a different size and shape from its scroll support.

The exemplary frame 53 of calendar 40 includes a frame opening 54 to leave at least the display areas of the scrolls 50, 44, 52 visible through the frame opening 54 when the frame 53 is in place covering the scroll support 57. Also, the frame opening 54 allows the user to easily change the display areas on the scrolls 50, 44, 52 by simply reaching through the frame opening 54 to move the scrolls 50, 44, 52 up or down. Advantageously, the outside 55 of the frame 53 may be decorated or include text or otherwise serve an informative or ornamental function.

In the FIG. 2 example, the frame 53 includes a single frame opening 54 with respect to the three scrolls 50, 44, 52 of the calendar 40. Other embodiments may include a frame opening for each scroll, and/or combinations of scrolls. For example, another embodiment may include a single frame opening for three scrolls such as shown in FIG. 2, and also include separate frame openings for each other scroll used in the information display. The openings in frames may be all of the same size, of varying sizes and shapes, etc., and/or be positioned variously.

Advantageously, the scroll support 47 and the frame 53 may be one folded piece of cardboard. This feature of the “integral”, “one-piece” or “unitary piece” construction of the scroll support 47 and the frame 53 is illustrated by the exemplary calendar 40 shown in FIG. 2, which is partially “unfolded” to show how the calendar 40 is put together. In this example, the scroll support 47 and the frame 53 constitute one piece of cardboard (other material(s), in whole or in part, may be used) that has been folded along a fold or score line 56. In other words, the scroll support 47 and the frame 53 are cut from the same piece of cardboard as a single piece, and then folded so that the frame 53 covers the scroll support 47. Other embodiments may include a scroll support and a frame as separate, but attached or positioned pieces. Moreover, a single information display may include more than one scroll support, more than one frame, and/or combination thereof, and as a unitary whole or as separate pieces. The scroll support 47 and the frame 53 (whether of one piece and/or separate pieces) may be glued, taped, stapled, or otherwise secured to maintain the position between the frame and the scroll support.

Besides framing the display area of a scroll, a frame may provide another advantageous feature relating to the movement of an information scroll(s) in the information display. In particular, the frame may cause some pressure on at least a part of an information scroll so as to facilitate movement of the information scroll between the openings in the scroll support. Generally, the frame covers the scroll support's openings used by the information scroll, but the frame opening leaves the display area of the scroll uncovered. So, the parts of the scroll nearest the openings, but not in or past the openings, may be more or less sandwiched between the scroll support and the frame. The pressure on the scroll caused by this “sandwiching” helps to keep the scroll in position and facilitates proper movement of the scroll when the user is changing display areas.

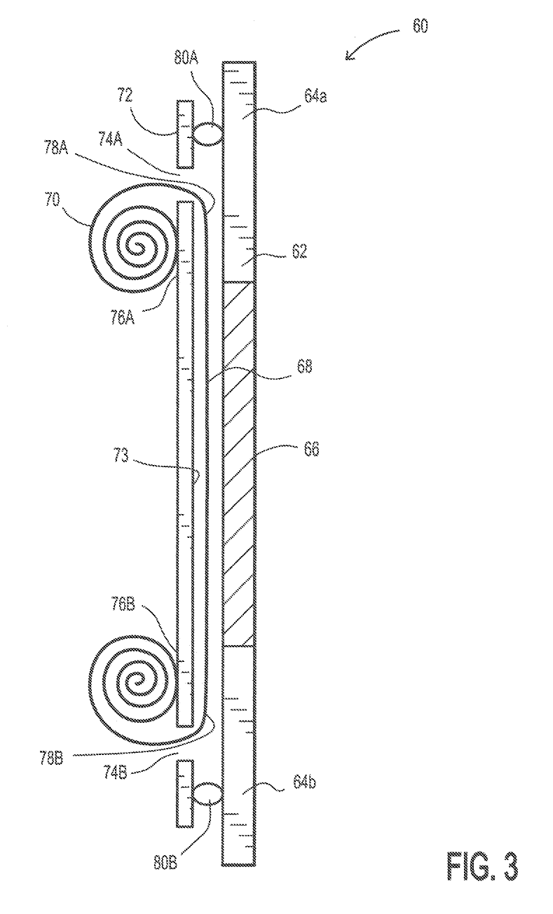

### FIG. 3—An Exemplary Embodiment

FIG. 3 illustrates the “sandwiching” effect mentioned in the previous paragraph by the slightly exploded side view of an exemplary information display 60, which includes a frame 62 having a top piece 64a and bottom piece 64. The side piece 66 of the frame 62 is shown in cutaway to reveal the sandwiching effect. The side piece 66 corresponds to the height of the frame opening displaying the display area 68 of the scroll 70. The display area 68 is positioned on a scroll support 72 (specifically, on the display side 73 of the scroll support 72), and between a top opening 74A in the scroll support 72 and a bottom opening 74B.

In particular, the sandwiching effect comes about by the fact that the frame 62 covers the scroll openings 74A-B and some parts 76A-B of the scroll support 72 inside adjacent to the scroll openings 74A-B. Thus, parts 78A-B of the scroll are positioned between the display side 73 of the scroll support 72 (adjacent to the scroll's openings 74A-B) and the frame 62. This “between” position is the “sandwiching effect”.

The elements in FIG. 3 are slightly exploded for this explanation, and they may touch or be in closer association with each other when the information display 60 is in use. Alternatively, the elements of an information display may be spaced slightly apart (as shown or otherwise) to allow for ease in movement of the information scroll in the changing of display area. This spacing may be accomplished in a number of ways including the manner of folding a one-piece element comprising the scroll support and the frame, and/or by the use of spacers 80A, B such as illustrated in FIG. 3 between the frame 62 and the scroll support 72. A spacer 49 is also shown on the display side of the scroll support 47 in the exemplary calendar 40 depicted in FIG. 2.

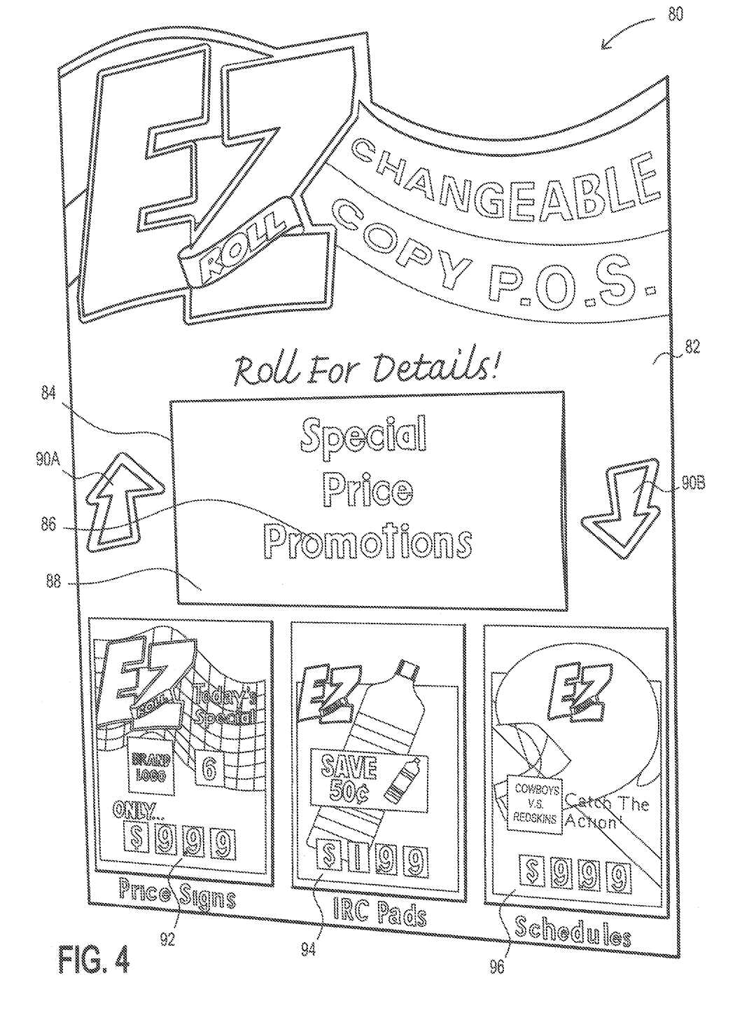

### FIG. 4—An Exemplary Embodiment

FIG. 4 illustrates another exemplary embodiment 80 of an information display according to the inventions. FIG. 4 is a front view of the information display 80 that includes a frame 82 with a frame opening 84 framing a display area 86 (“In-Store Redeemable Coupons”) of a relatively large information scroll 88. As indicated by the arrows 90A, B, the scroll 88 may be rolled up or down to change the display area 86 to something else.

On the front of its frame 82, the information display 80 advertises three other such information displays 92, 94, 96. Each of these other displays 92, 94, 96 illustrate that such displays may include more than one information scroll, information scrolls of different sizes and shapes, and of various placement.

Advantageously, the information displays have many applications. For example, the changeable information displays may be used with and in rate boards, menu boards, calendars, rotating price points, store hours, shelf edge pricing, product information/identification, convenience stores, grocery stores, mass retail pricers, cooler signs, feature boards, medical information, automotive service centers, directional signage, gas station pricers, home improvement centers, inventory management, stock/commodity pricing, transportation facilities, discount stores, store layout, mass retail, schedules, message rolls, and many more.

From the foregoing description of the exemplary embodiments of the inventions and operation thereof, other embodiments will suggest themselves to those skilled in the art. Therefore, the scope of the inventions is to be limited only by the claims below and equivalents thereof.

I claim:

1. An information display, comprising:
an information scroll having two opposite ends, and having an inner surface and an outer surface with two or more display areas;
a scroll support having a display side and a retaining side opposite the display side,
the scroll support including a first opening and a second opening,
the first opening receiving a first end of the information scroll and the second opening receiving a second end of the information scroll so that the first and second ends rest behind the retaining side of the scroll support with the outer surface of the information scroll being visible between the first and second openings on the display side of the scroll support;
the information scroll being positionable between the first and second openings so as to selectively display at least one of the two or more display areas, and
the first opening of the scroll support including at least a tick, and
the information scroll including at least a tick catcher near termination of the first end of the information scroll, whereby the tick catcher catches the tick of the first opening to retain the termination of the first end of the information scroll in the first opening; and
a frame for framing the display side of the scroll support, the frame having a frame opening at least as large as the largest of the two or more display areas of the information scroll.

2. The information display of claim 1, wherein the two opposite ends of the information scroll comprise ends that are coilable towards each other and towards the inner surface of the information scroll.

3. The information display of claim 1, further comprising another information scroll which may be positioned next to the first information scroll so that at least a display area of the second information scroll is visible between the first and second openings on the display side of the scroll support.

5. The information display of claim 1, further comprising another information scroll having a display side; and
wherein the scroll support includes a third opening and a fourth opening,
whereby the third opening receives a first end of the another information scroll and the fourth opening receives a second end of the another information scroll so that the first and second ends of the another information scroll rest against the retaining side of the scroll support with the display area of the another information scroll being visible between the third and fourth openings on the display side of the scroll support.

6. The information display of claim 1, wherein the scroll support and the frame comprise a unitary piece.

7. The information display of claim 1, wherein framing of the display side of the scroll support by the frame causes at least some pressure on at least a part of the information scroll so as to facilitate movement of the information scroll between the first and second openings in the scroll support.

8. The information display of claim 1, further comprising one or more spacers inserted between the scroll support and the frame.

9. The information display of claim 1, wherein the first opening is spaced apart from the second opening on the scroll support by about either the height or the width of the display area of the information scroll.

10. The information display of claim 1, wherein the information scroll is positionable between the first and second openings so as to selectively serially display the two or more display areas one-at-a-time.

11. An information display, comprising:
an information scroll having an inner surface and having an outer surface with at least a display area,
the information scroll having two ends coilable towards each other and towards the inner surface of the information scroll; and
a scroll support having a display side and a retaining side opposite the display side,
the scroll support including a first opening and a second opening,
whereby the first opening receives a first coiled end of the information scroll and the second opening receives a second coiled end of the information scroll so that the first and second coiled ends rest against the retaining side of the scroll support with the display area of the information scroll being visible between the first and second openings on the display side of the scroll support.

12. The information display of claim 11, wherein the outer surface of the information scroll comprises two or more display areas; and
wherein any one of the two or more display areas is positionable between the first and second openings.

13. The information display of claim 11, further comprising another information scroll which may be positioned next to the first information scroll so that at least a display area of the second information scroll is visible between the first and second openings on the display side of the scroll support.

14. The information display of claim 11, wherein the first opening of the scroll support includes at least a tick, and
wherein the information scroll includes at least a tick catcher near termination of the first coiled end of the information scroll,
whereby uncoiling the first coiled end of the information scroll to the tick catcher results in the tick catcher catching the tick of the first opening and causing retention of the termination of the first coiled end of the information scroll in the first opening.

15. The information display of claim 11, further comprising another information scroll having a display side; and
wherein the scroll support includes a third opening and a fourth opening,
whereby the third opening receives a first coiled end of the another information scroll and the fourth opening receives a second coiled end of the another information scroll so that the first and second coiled ends of the another information scroll rest against the retaining side of the scroll support with the display area of the another information scroll being visible between the third and fourth openings on the display side of the scroll support.

16. The information display of claim 11, further comprising a frame for framing the display side of the scroll support,
the frame having a frame opening at least as large as the display area of the information scroll for displaying the display area of the information scroll.

17. A method for displaying information, comprising:
causing an information scroll to include at least an information display on a display side of the information scroll, the information scroll being coilable from either end towards an inner side of the information scroll opposite to the display side of the information scroll;
providing a scroll support for supporting the information scroll between a first opening, which receives at least a first end of the information scroll, and a second opening, which receives at least second end of the information scroll; and
causing the information display to be displayed between the first and second openings of the scroll support by causing a first end of the information scroll to coil and the second end of the information scroll to uncoil until the information display is positioned substantially between the first and second openings of the scroll support.

18. The method of claim 17, wherein the information scroll comprises another information display on the display side of the information scroll; and
wherein causing the first end of the information scroll to coil and the second end of the information scroll to uncoil results in the another information display being positioned substantially between the first and second openings of the scroll support.

19. The method of claim 17, wherein causing the first end of the information scroll to coil comprises causing the first end of the information scroll to further coil.

20. The method of claim 17, further comprising providing a frame for framing the information display between the scroll support and the frame.
